(19) United States
(12) Patent Application Publication
(10) Pub. No.: US 2022/0129939 A1
(43) Pub. Date: Apr. 28, 2022

(54) COMMODITY REGISTRATION APPARATUS AND COMMODITY REGISTRATION METHOD

(71) Applicant: TOSHIBA TEC KABUSHIKI KAISHA, Tokyo (JP)

(72) Inventor: Masaya YAMADA, Izu Shizuoka (JP)

(21) Appl. No.: 17/393,776

(22) Filed: Aug. 4, 2021

(30) Foreign Application Priority Data
Oct. 27, 2020 (JP) 2020-179678

(51) Int. Cl. G06Q 30/02; G06Q 20/38; G06F 16/28

(52) U.S. Cl. CPC G06Q 30/0238; G06Q 20/208; G06F 16/285; G06Q 20/387

(57) ABSTRACT

According to an embodiment, a commodity registration apparatus detects a classification mode switching instruction for switching the classification mode for commodity registration. The commodity registration apparatus switches a commodity registration mode from a first classification mode to a second classification mode in response to the detection of the classification mode switching instruction. Further, the commodity registration apparatus registers a commodity to be registered as a commodity belonging to a second classification in the second classification mode.

### CROSS-REFERENCE TO RELATED APPLICATIONS

This application is based upon and claims the benefit of priority from the prior Japanese Patent Application No. 2020-179678, filed on Oct. 27, 2020, the entire contents of which are incorporated herein by reference.

### FIELD

Embodiments described herein generally relate to a commodity registration apparatus and a commodity registration method.

### BACKGROUND

Conventionally, there has been known a commodity registration apparatus such as a point-of-sales (POS) terminal having a function of selling and processing, for example, a price of a commodity wrapping service, a price of a plastic shopping bag, or a sales item as a non-commodity section item.

In a POS system operating in a commercial establishment such as a supermarket, commodities and services to be sold and processed as non-commodity section items are set in advance as non-commodity section items. The commodities and services set as the non-commodity section items are managed so as to be distinguished from ordinary commodities for commodity registration.

However, there is a possibility that the commodities and services belonging to the non-commodity section items may be changed depending on the management policy of the store. For this reason, it is desired to provide a means for easily setting commodities and services to be processed as non-commodity section items.

### BRIEF DESCRIPTION OF THE DRAWINGS

FIG. 1 is a block diagram showing a circuit configuration of a POS terminal according to an embodiment.

FIG. 2 is a diagram showing an exemplary commodity registration screen displayed on a display device of the POS terminal according to the embodiment.

FIG. 3 is a diagram showing another exemplary commodity registration screen displayed on the display device of the POS terminal according to the embodiment.

FIG. 4 is a flowchart showing commodity registration processing by the POS terminal according to the embodiment.

### DETAILED DESCRIPTION

According to one embodiment, a commodity registration apparatus registers a commodity to be sold in a commodity registration mode. The commodity registration apparatus includes an input device and a processor. The input device inputs a classification mode switching instruction for switching the commodity registration mode from a first classification mode to a second classification mode. The processor detects an input of the classification mode switching instruction by the input device. The processor switches the commodity registration mode from the first classification mode to the second classification mode in response to the detected classification mode switching instruction. The processor registers a commodity to be registered as a commodity belonging to a first classification when the commodity registration mode is the first classification mode. Further, the processor registers a commodity to be registered as a commodity belonging to a second classification different from the first classification when the commodity registration mode is switched from the first classification mode to the second classification mode.

Embodiments will be described below with reference to the drawings. The same reference symbols in the drawings will denote the same or similar portions. Note that, in this embodiment, a POS terminal is exemplified as one aspect of a commodity registration apparatus. The POS terminal functions as a commodity registration apparatus with which a sales clerk performs operations from registration to settlement of a commodity.

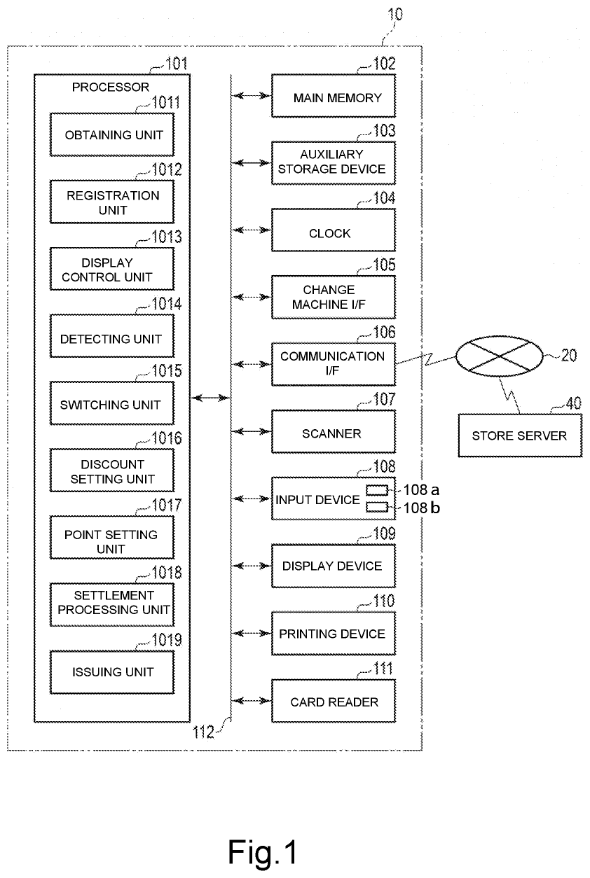

FIG. 1 is a block diagram showing a circuit configuration of a POS terminal 10 according to an embodiment. The POS terminal 10 includes a processor 101, a main memory 102, an auxiliary storage device 103, a clock 104, a change machine interface 105, a communication interface 106, an input device 108, a display device 109, a printing device 110, a scanner 107, a card reader 111, and a system bus 112. In the POS terminal 10, the processor 101, the main memory 102, the auxiliary storage device 103, the clock 104, the change machine interface 105, the communication interface 106, the input device 108, the display device 109, the printing device 110, the scanner 107, and the card reader 111 are electrically connected to the system bus 112 directly or via a signal input/output circuit. In FIG. 1, the interface is referred to as “I/F”.

The POS terminal 10 constitutes a computer by the processor 101, the main memory 102, the auxiliary storage device 103, and the system bus 112 that connects them.

The processor 101 corresponds to the central part of the computer descried above. For example, the processor 101 is a central processing unit (CPU), but is not limited thereto. The processor 101 may include various circuits. The processor 101 loads a control program, which is stored in advance in the main memory 102 or the auxiliary storage device 103, into the main memory 102. The processor 101 executes the control program loaded into the main memory 102 to implement various portions to be described later and execute various operations.

The main memory 102 corresponds to the main storage portion of the computer. The main memory 102 includes a non-volatile memory region and a volatile memory region. The main memory 102 stores an operating system and a control program in the non-volatile memory region. In addition, the main memory 102 may store data necessary for the processor 101 to execute the processing for controlling each unit in the non-volatile or volatile memory region. The volatile memory region of the main memory 102 is used as a work area in which data is appropriately rewritten by the processor 101.

The auxiliary storage device 103 corresponds to the auxiliary storage portion of the computer. For example, an electric erasable programmable read-only memory (EEPROM) (registered trademark), a hard disk drive (HDD), a solid state drive (SSD), or the like is used as the auxiliary storage device 103. The auxiliary storage device 103 stores data used for the processor 101 to perform various types of processing, and data generated in the processing of the processor 101. The auxiliary storage device 103 may store the control program.

The clock 104 functions as a time information source for the POS terminal 10. The processor 101 measures the present date and time on the basis of the time information measured by the clock 104.

The change machine interface 105 inputs and outputs data signals to and from an automatic change machine (not shown). For example, the change machine interface 105 inputs deposit amount data from the automatic change machine. Further, the change machine interface 105 outputs change amount data to the automatic change machine. Incidentally, in the automatic change machine, bills or coins corresponding to the change amount corresponding to the change amount data are paid out.

The communication interface 106 is connected to a network 20 and performs data communication with other devices connected to the network 20 according to a predetermined communication protocol. A store server 40 for managing prices, sales, stocks, and the like of commodities to be sold and purchased at the store is connected to the network 20. The network 20 is typically a local area network (LAN). The LAN may be wired or wireless.

The store server 40 controls the processing related to the registration and settlement of commodities, which are executed by each POS terminal 10. Further, the store server 40 collects data processed by each POS terminal 10 through the network 20, processes the data appropriately, and stores the data in a data file.

The scanner 107 includes a reading window. The scanner 107 scans a bar code of a commodity to be registered (hereinafter, simply referred to as commodity), which is passed over the reading window, and reads the bar code of the commodity. A bar code symbol in which a commodity code for identifying the commodity is bar-coded, is attached to an ordinary commodity to be sold in the store. The ordinary commodity is an ordinary commodity registered in an ordinary commodity registration mode. The ordinary commodity corresponds to a commodity belonging to a first classification. The commodity code is unique identification information assigned to each ordinary commodity in order to individually identify the ordinary commodity. The commodity code is also referred to as commodity identification information. The scanner 107 reads the bar code every time the bar code symbol attached to the commodity is passed over the reading window.

Further, for commodities or services belonging to a second classification (non-commodity section items) different from the first classification, bar code symbols in which non-commodity article codes for identifying such commodities or services are bar-coded are attached thereto. Unlike the ordinary commodities, the non-commodity section items are items recorded separately from the sales of the ordinary commodities, such as a price of a commodity wrapping service, a price of a plastic shopping bag, and a sales item. Commodities or services belonging to the non-commodity section items are each referred to as a non-commodity article. The non-commodity article corresponds to a commodity in the second classification. The non-commodity article code is unique identification information assigned to each non-commodity article in order to individually identify the non-commodity article. The non-commodity article code is also referred to as non-commodity article identification information. The scanner 107 reads the bar code every time the bar code symbol attached to the non-commodity article is passed over the reading window.

Further, the scanner 107 scans and reads a privilege bar code attached to a coupon, a discount ticket, or the like passed over the reading window. The privilege bar code is a printed matter given to a medium such as a coupon or a discount ticket or is an image displayed on a terminal such as a smartphone. The privilege of the coupon, the discount ticket, the point ticket, or the like is provided with a bar code symbol in which a privilege code for identifying the privilege is bar-coded. The privilege code is also referred to as privilege identification information. The privilege code is associated with privilege information indicating the contents of the privilege.

Here, the bar code may be regarded as a two-dimensional data code. The scanner 107 may be of a type in which the code symbol is read by laser beam scanning. The scanner 107 may be of a type in which the code symbol is read from an image captured by an imaging device such as a camera.

The input device 108 is a device that functions as a data input interface to the POS terminal 10. For example, the input device 108 may be a keyboard, a touch panel, or the like. The input device 108 includes a “switch” button 108a for inputting a classification mode switching instruction to switch a classification mode for commodity registration.

The classification mode switching instruction is an instruction to switch a classification mode for commodity registration. The “switch” button 108a is an example of a classification mode switching button. The “switch” button 108a is an example of a classification mode switching instruction. The classification mode for commodity registration includes an ordinary commodity registration mode and a non-commodity article registration mode. The ordinary commodity registration mode is a classification mode for registering ordinary commodities. The ordinary commodity registration mode corresponds to a first classification mode. The non-commodity article registration mode is a classification mode for registering non-commodity articles. The non-commodity article registration mode corresponds to a second classification mode.

The input device 108 includes a “back” button 108b for inputting a classification mode switching cancellation instruction for commodity registration. The classification mode switching cancellation instruction is an instruction to cancel the switching of the classification mode. Canceling the switching of the classification mode includes returning the classification mode set after the switching to the classification mode set before the switching. The “back” button 108b is an example of a classification mode switching cancellation button. The classification mode switching cancellation button 108b is an example of a classification mode switching cancellation instruction.

The “switch” button 108a and the “back” button 108b may be soft keys reproduced on a touch panel or may be hardware keys arranged on a keyboard.

The display device 109 is a device capable of displaying various screens under the control of the processor 101. The display device 109 may be separately provided as a sales clerk device and a customer device. For example, the display device 109 may be a liquid crystal display, an electroluminescence (EL) display, or the like.

The printing device 110 is a device for printing receipts, slips, and the like. For example, the printing device 110 is a thermal printer, an ink jet printer, or the like.

The card reader 111 reads the card data recorded on the magnetic stripe of a card medium.

Note that the hardware configuration of the POS terminal 10 is not limited to the configuration described above. The POS terminal 10 allows the omission and modification of the above constituent elements and the addition of new constituent elements appropriately.

Note that FIG. 1 shows only the POS terminal 10 as a commodity registration apparatus connected to the network 20. However, a so-called semi-self-service settlement apparatus (checkout apparatus) with which a sales clerk performs commodity registration and a customer performs settlement may be connected to the network 20. In such a case, the store server 40 controls semi-self-service POS terminals together as well as the POS terminal 10.

Each unit implemented in the processor 101 described above will be described. The processor 101 implements an obtaining unit 1011, a registration unit 1012, a display control unit 1013, a detection unit 1014, a switching unit 1015, a discount setting unit 1016, a point setting unit 1017, a settlement processing unit 1018, and an issuing unit 1019. Each unit implemented in the processor 101 can also be referred to as each function. It can also be said that each unit implemented in the processor 101 is implemented in a controller including the processor 101 and the main memory 102.

The obtaining unit 1011 obtains data of various codes. The various codes are described as ones read by the scanner 107, but may be input with the input device 108. Hereinafter, the phrase “read by the scanner 107” may be regarded as “read by the scanner 107 or input with the input device 108”. The obtaining unit 1011 obtains various types of information on the basis of the obtained data.

In one example, when the bar code of an ordinary commodity is read by the scanner 107, the obtaining unit 1011 obtains the commodity code indicated by the bar code of the ordinary commodity. The obtaining unit 1011 obtains commodity sales information associated with the obtained commodity code. The commodity sales information corresponds to various types of information associated with the commodity code. The commodity sales information includes a sales amount and the like. The commodity sales information may be stored in advance in the auxiliary storage device 103 or may be downloaded from the store server 40 to the POS terminal 10 via the network 20. The commodity sales information may be appropriately updated.

In another example, when the bar code of a non-commodity article is read by the scanner 107, the obtaining unit 1011 obtains a non-commodity article code indicated by the bar code of the non-commodity article. The obtaining unit 1011 obtains non-commodity article sales information associated with the obtained non-commodity article code. The non-commodity article sales information corresponds to various types of information associated with the non-commodity article code. The non-commodity article sales information includes a sales amount and the like. The non-commodity article sales information may be stored in advance in the auxiliary storage device 103 or may be downloaded from the store server 40 to the POS terminal 10 via the network 20. The non-commodity article sales information may be appropriately updated.

When a member code recorded on a member card is read by the card reader 111, the obtaining unit 1011 obtains the member code. The member code may be read by the scanner 107 from a code symbol such as a bar code attached to the member card.

The obtaining unit 1011 also obtains a privilege code read by the scanner 107 and obtains privilege information associated with the privilege code. The fact that the privilege code is obtained by the obtaining unit 1011 corresponds to the fact that the privilege code is read by the scanner 107. Obtaining the privilege code corresponds to reading the privilege code or inputting the privilege code. The privilege information corresponds to various types of information associated with the privilege code and includes information such as the validity of the privilege code, the contents of the privilege, and the like. A database associated with the privilege code and the privilege information may be stored in advance in the auxiliary storage device 103 or may be downloaded from the store server 40 or a server (not shown) to the POS terminal 10 via the network 20. The database may be appropriately updated.

The registration unit 1012 registers various types of information on the basis of the data read by the scanner 107. In one example, when the bar code of the ordinary commodity is read by the scanner 107, the registration unit 1012 registers the commodity sales information of the commodity obtained by the obtaining unit 1011.

In another example, when the bar code of the non-commodity article is read by the scanner 107, the registration unit 1012 registers the non-commodity article sales information of the non-commodity article obtained by the obtaining unit 1011. For example, when the obtaining unit 1011 obtains the non-commodity article code, the registration unit 1012 sets a classification flag indicating the non-commodity article in the auxiliary storage device 103. For example, the classification flag when the non-commodity article code is obtained is set to “1”, and the classification flag when the non-commodity article code is not obtained is set to “0”.

The display control unit 1013 causes the display device 109 to display various images. The display control unit 1013 switches the image in response to an input made by an operator via the input device 108 and causes the display device 109 to display an image. Hereinafter, “in response to” may be regarded as “on the basis of”.

The detection unit 1014 detects a touch input to the screen by the operator via the input device 108. The touch input is performed by the operator touching the screen according to various images displayed on the input device 108. The screen on which images are displayed includes a button for specifying the operation. The operator specifies an operation by touching the displayed button. The detection unit 1014 may detect inputs using hardware keys arranged in the keyboard.

The switching unit 1015 switches the classification mode for commodity registration on the basis of various inputs of the input device 108. For example, the switching unit 1015 switches the classification mode from the ordinary commodity registration mode to the non-commodity article registration mode on the basis of the input of the classification mode switching instruction according to the selection of the “switch” button 108a of the input device 108. For example, the switching unit 1015 switches the classification mode from the non-commodity article registration mode to the ordinary commodity registration mode on the basis of the input of the classification mode switching cancellation instruction according to the selection of the “back” button 108b of the input device 108.

The discount setting unit 1016 sets whether or not to apply a discount to the registered commodity according to the classification mode. For example, the discount setting unit 1016 sets “discount applicable” for a commodity registered in the ordinary commodity registration mode. The discount setting unit 1016 sets “discount not applicable” for a non-commodity article registered in the non-commodity article registration mode. For example, the discount setting unit 1016 sets whether or not to apply a discount on the basis of the classification flag.

The point setting unit 1017 sets whether or not to apply points to the registered commodity according to the classification mode. For example, the point setting unit 1017 sets “point applicable” for a commodity registered in the ordinary commodity registration mode. The point setting unit 1017 sets “point not applicable” for a non-commodity article registered in the non-commodity article registration mode. For example, the point setting unit 1017 sets whether or not to apply points on the basis of the classification flag.

The settlement processing unit 1018 executes settlement processing. For example, the settlement processing unit 1018 executes settlement processing in accordance with the selection of a payment method by a customer, which will be described later.

The issuing unit 1019 operates the printing device 110 and issues a receipt representing the contents of the present commercial transaction.

Note that the detection unit 1014 and the switching unit 1015 have been described as being implemented in the processor 101 by executing programs, but they are not limited thereto. The detection unit 1014 and the switching unit 1015 may be implemented by the input device 108. The detection unit 1014 and the switching unit 1015 may be implemented by cooperation between the processor 101 and the input device 108 by executing programs.

Next, an example of a screen displayed on the display device 109 will be described.

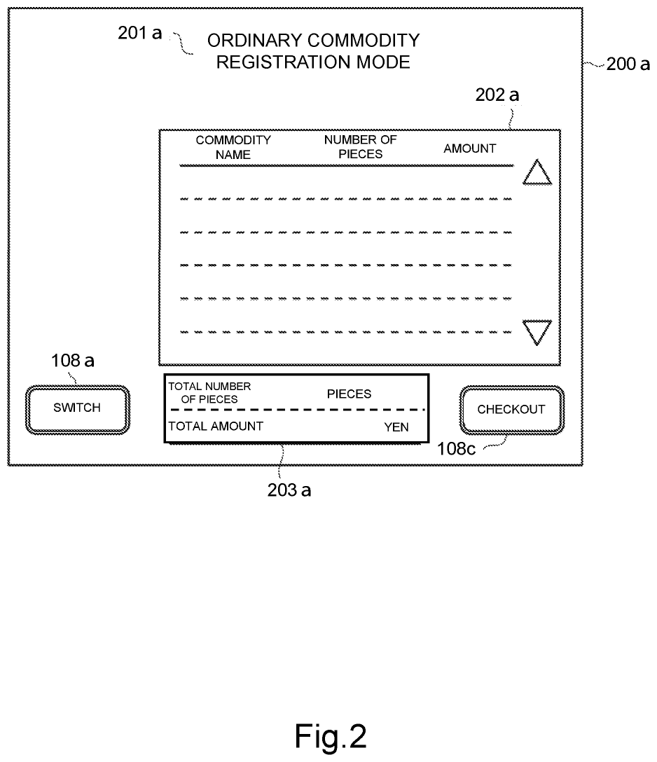

FIG. 2 is a diagram showing an exemplary commodity registration screen displayed on the display device 109 of the POS terminal 10 according to the embodiment. This example shows a commodity registration screen in the ordinary commodity registration mode. The operator is normally a sales clerk, but may be another operator. As shown in the figure, a mode notification 201a showing the classification mode for commodity registration to the operator is displayed on a commodity registration screen 200a. The mode notification 201a indicates that the mode is the ordinary commodity registration mode. Further, a description field 202a for displaying the description of the registered commodities and a total field 203a for displaying the total of the registered commodities are displayed on the commodity registration screen 200a. Furthermore, the “switch” button 108a for the operator to switch the classification mode for commodity registration and a “checkout” button 108c for the operator to specify the transition to the settlement processing are displayed on the commodity registration screen 200a. When the “switch” button 108a is touched by the operator, the classification mode is switched from the ordinary commodity registration mode to the non-commodity article registration mode. The mode notification 201a is not limited to text display and may be displayed using an icon, a moving image, or the like. The mode notification 201a only needs to be an aspect distinguishable from a mode notification 201b to be described later. The commodity registration screen 200a in the ordinary commodity registration mode is an exemplary first commodity registration screen.

First, the operator registers an ordinary commodity to be purchased by the customer in accordance with the commodity registration screen 200a. The operator who has confirmed the commodity registration screen 200a passes the bar code portion of the ordinary commodity over the reading window of the scanner 107. The bar code is then read by the scanner 107, and the ordinary commodity is registered. During the registration of the ordinary commodity, a privilege code attached to a coupon, a discount ticket, or the like held by the customer can also be passed over the reading window. In this case, the privilege code is read by the scanner 107, and information indicating that the privilege code has been obtained is registered. When the registration of all the ordinary commodities is completed and the registration of non-commodity articles is not necessary, the operator touches the “checkout” button 108c. On the other hand, when the registration of all the ordinary commodities is completed and the registration of non-commodity articles is necessary, the operator touches the “switch” button 108a. The classification mode for commodity registration is switched from the ordinary commodity registration mode to the non-commodity article registration mode on the basis of the touch input of the “switch” button 108a by the operator.

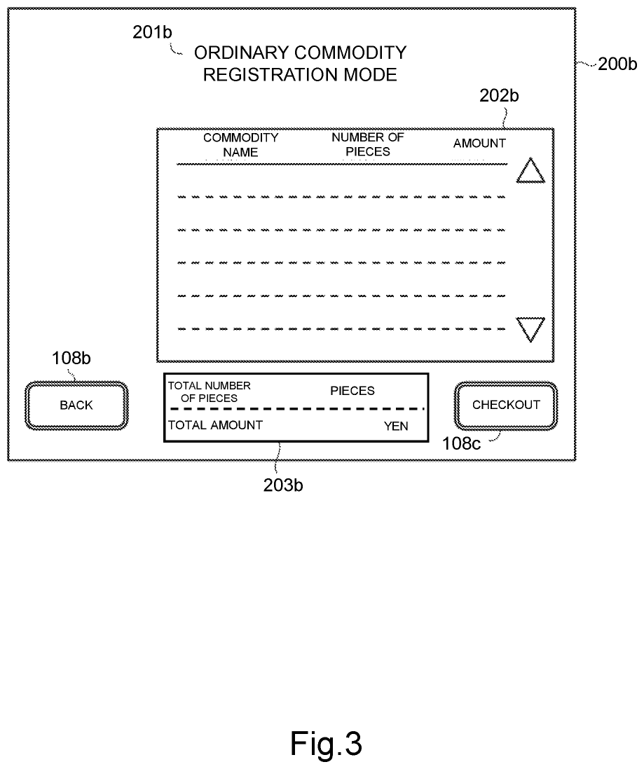

FIG. 3 is a diagram showing another exemplary commodity registration screen displayed on the display device 109 of the POS terminal 10 according to the embodiment. This example shows a commodity registration screen in the non-commodity article registration mode. The operator is normally a sales clerk, but may be another operator. As shown in the figure, a mode notification 201b showing the classification mode for commodity registration to the operator is displayed on a commodity registration screen 200b. The mode notification 201b indicates that the mode is the non-commodity article registration mode. Further, a description field 202b for displaying the description of the registered commodities and a total field 203b for displaying the total of the registered commodities are displayed on the commodity registration screen 200b. The description field 202b may be displayed in an aspect distinguishable from the description field 202a, such as a different background color from the description field 202a. Furthermore, a “back” button 108b for the operator to switch the classification mode for commodity registration and a “checkout” button 108c for the operator to specify the transition to the settlement processing are displayed on the commodity registration screen 200b. When the “back” button 108b is touched by the operator, the classification mode is switched from the non-commodity article registration mode to the ordinary commodity registration mode. The mode notification 201b is not limited to text display and may be displayed using an icon, a moving image, or the like. The mode notification 201b only needs to be an aspect distinguishable from the mode notification 201a described above. The commodity registration screen 200b in the non-commodity article registration mode is an exemplary second commodity registration screen.

First, the operator registers a non-commodity article to be purchased by the customer in accordance with the commodity registration screen 200b. The operator who has confirmed the commodity registration screen 200b passes the bar code portion of the non-commodity article over the reading window of the scanner 107. The bar code is then read by the scanner 107, and the non-commodity article is registered. If the bar code is not attached to the non-commodity article, a corresponding input of the non-commodity article is performed via the input device 108. When the registration of all the non-commodity articles is completed, the operator touches the “checkout” button 108c. Note that, when the registration of ordinary commodities is necessary after the registration of all the non-commodity articles is completed, the operator touches the “back” button 108b. The classification mode for commodity registration is switched from the non-commodity article registration mode to the ordinary commodity registration mode on the basis of the touch input of the “back” button 108b by the operator.

According to this example, the POS terminal 10 can display the mode notification 201b and the description field 202b in the non-commodity article registration mode separately from the ordinary commodity registration mode. As a result, the operator can easily recognize that the mode is the non-commodity article registration mode. In addition, the POS terminal 10 can switch the classification mode for commodity registration by detecting the input of the “back” button 108b. Therefore, the operator can easily switch the classification mode for commodity registration from the non-commodity article registration mode to the ordinary commodity registration mode.

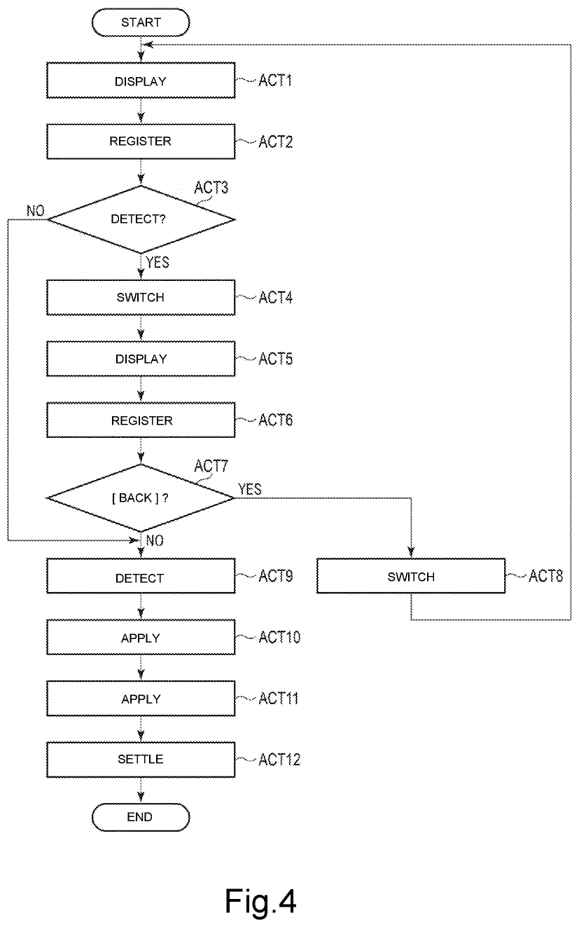

Next, the procedures of the commodity registration processing by the POS terminal 10 will be described. FIG. 4 is a flowchart showing the commodity registration processing by the processor 101 of the POS terminal 10 according to the embodiment.

Note that the processing procedure to be described below is merely an example, and each processing step may be changed as much as possible. Further, the steps of the processing procedure to be described below can be appropriately omitted, replaced, and added depending on the embodiment. Note that the operator may be regarded as a sales clerk, a customer, or a person. In addition, unless otherwise specified, the operator of the POS terminal 10 is normally a sales clerk, but may be another operator.

First, an operator performs an operation for registering an ordinary commodity to be purchased by a customer in the ordinary commodity registration mode. When the settlement processing for the immediately preceding customer is completed, the POS terminal 10 starts the commodity registration processing shown in the flowchart of FIG. 4 in the ordinary commodity registration mode. Note that the timing at which the commodity registration processing is started is not limited to this timing. For example, a basket table attached to the POS terminal 10 may be provided with a sensor for detecting that the basket is placed. When the basket is detected by this sensor, the POS terminal 10 may start the commodity registration processing. Alternatively, the POS terminal 10 may automatically start the commodity registration processing when a certain period of time has elapsed after the processing for the immediately preceding customer is completed.

In ACT1 of FIG. 4, the display control unit 1013 of the processor 101 causes the display device 109 to display the commodity registration screen 200a (see FIG. 2). The operator performs an operation in accordance with the commodity registration screen 200a.

In ACT2, the registration unit 1012 of the processor 101 registers various types of information on the basis of the data read by the scanner 107. Specifically, in ACT2, for example, the obtaining unit 1011 of the processor 101 obtains the commodity code of an ordinary commodity read by the scanner 107 in response to reading of the bar code of the ordinary commodity by the scanner 107. The registration unit 1012 of the processor 101 registers the ordinary commodity on the basis of the commodity sales information associated with the commodity code of the ordinary commodity obtained by the obtaining unit 1011. Next, the display control unit 1013 of the processor 101 displays the commodity names of ordinary commodities, the number of sold commodities, and the sales amount in the description field 202a of the commodity registration screen 200a on the basis of the commodity sales information. Further, the settlement processing unit 1018 of the processor 101 calculates the total number of ordinary commodities and the total amount at the present moment on the basis of the commodity sales information stored in the auxiliary storage device 103, and displays them in the total field 203a of the commodity registration screen 200a.

Further, in ACT2, for example, the registration unit 1012 of the processor 101 registers privilege information associated with the privilege code in response to the fact that the privilege code is read by the scanner 107. In this example, the obtaining unit 1011 of the processor 101 obtains the privilege code read by the scanner 107 in response to the fact that the privilege code is read by the scanner 107. The registration unit 1012 of the processor 101 registers the privilege information on the basis of the privilege code obtained by the obtaining unit 1011.

In ACT3, the detection unit 1014 of the processor 101 detects an input of the “switch” button 108a. Specifically, in ACT3, for example, the detection unit 1014 detects a touch input of the “switch” button 108a by the operator on the commodity registration screen 200a (see FIG. 2). The detection of the touch input of the “switch” button 108a by the detection unit 1014 is an example of performing the touch input of the “switch” button 108a. For example, the detection unit 1014 detects that the “switch” button 108a has been touched on the basis of a signal from the input device 108.

In ACT3, if the detection unit 1014 of the processor 101 detects an input of the “switch” button 108a (ACT3: Yes), the processing of the processor 101 shifts from ACT3 to ACT4. If the detection unit 1014 does not detect an input of “switch” button 108a (ACT3: NO), the processing of the processor 101 shifts from ACT3 to ACT9.

In ACT4, the switching unit 1015 of the processor 101 switches the classification mode for commodity registration from the ordinary commodity registration mode to the non-commodity article registration mode in response to the detection of the input of the “switch” button 108a by the detection unit 1014.

According to this example, providing the “switch” button 108a allows the POS terminal 10 to switch the classification mode for commodity registration by detecting the input of the “switch” button 108a. Therefore, even if the non-commodity articles are not set in advance in the auxiliary storage device 103, the store server 40, or the like, the POS terminal 10 is capable of easily setting the commodities or services belonging to the non-commodity section items, and registering the non-commodity articles separately from the ordinary commodities in the POS terminal 10. This can save the memory resources of the POS terminal 10 or the store server 40. In addition, even if the operation policy of the non-commodity articles by the store is changed, the operator can easily register the ordinary commodities and the non-commodity articles separately from each other in the POS terminal 10 according to the operation policy. Therefore, it is not necessary to change the setting of the non-commodity articles according to the changed operation policy.

Next, in ACT5, the display control unit 1013 of the processor 101 causes the display device 109 to display the commodity registration screen 200b (see FIG. 3).

Specifically, in ACT5, for example, the display control unit 1013 switches the display screen of the display device 109 from the commodity registration screen 200a to the commodity registration screen 200b, and causes the display device 109 to display the commodity registration screen 200b. The display control unit 1013 causes the display device 109 to display the commodity registration screen 200b in an aspect distinguishable as a screen of a mode different from the ordinary commodity registration mode.

According to this example, the POS terminal 10 performs display by switching the display screen image of the display device 109 according to the classification mode for commodity registration. Thus, the operator can distinguish the ordinary commodity registration mode from the non-commodity article registration mode on the display screen of the display device 109. As a result, the operator can easily recognize that the mode is the non-commodity article registration mode.

Next, in ACT6, the registration unit 1012 of the processor 101 registers various types of information on the basis of the data read by the scanner 107. Specifically, in ACT6, for example, the obtaining unit 1011 of the processor 101 obtains the non-commodity article code of a non-commodity article read by the scanner 107 in response to reading of the bar code of the non-commodity article by the scanner 107. The registration unit 1012 of the processor 101 then registers the non-commodity article on the basis of the non-commodity article sales information associated with the non-commodity article code obtained by the obtaining unit 1011.

The registration unit 1012 then registers the non-commodity article as a commodity in the non-commodity article registration mode. Furthermore, when registering non-commodity articles, the registration unit 1012 sets the classification flag “1” indicating a non-commodity article in the auxiliary storage device 103. Next, the display control unit 1013 displays the commodity names of non-commodity articles, the number of sold non-commodity articles, and sales amount in the description field 202b of the commodity registration screen 200b on the basis of the non-commodity article sales information. Further, the settlement processing unit 1018 of the processor 101 calculates the total number of non-commodity articles and the total amount at the present moment on the basis of the non-commodity article sales information stored in the auxiliary storage device 103. The settlement processing unit 1018 then displays the calculated total number of non-commodity commodities and total amount in the total field 203b of the commodity registration screen 200b.

Next, in ACT7, the detection unit 1014 of the processor 101 detects an input of the “back” button 108b. Specifically, in ACT7, for example, the detection unit 1014 detects a touch input of the “back” button 108b by the operator on the commodity registration screen 200b (see FIG. 3). If the detection unit 1014 detects an input of the “back” button 108b (ACT7: YES), the processing of the processor 101 shifts from ACT7 to ACT8. On the other hand, if the detection unit 1014 does not detect an input of the “back” button 108b (ACT7: NO), the processing of the processor 101 shifts from ACT7 to ACT9.

In ACT8, the switching unit 1015 of the processor 101 switches the classification mode for commodity registration from the non-commodity article registration mode to the ordinary commodity registration mode in response to the detection of the input of the “back” button 108b by the detection unit 1014.

According to this example, providing the “back” button 108b allows the POS terminal 10 to switch the classification mode for commodity registration by detecting the input of the “back” button 108b. Therefore, the operator can easily switch the classification mode for commodity registration from the non-commodity article registration mode to the ordinary commodity registration mode.

Next, in ACT9, the detection unit 1014 of the processor 101 detects an input of the “checkout” button 108c. Specifically, in ACT9, for example, the detection unit 1014 detects a touch input of the “checkout” button 108c by the operator on the commodity registration screen. The touch input of the “checkout” button 108c is an example of a checkout instruction. The checkout instruction is an instruction for terminating the registration processing of commodities and shifting from the registration processing to the settlement processing. The detection of the touch input of the “checkout” button 108c by the detection unit 1014 is an example of performing the touch input of the “checkout” button 108c. For example, the detection unit 1014 detects that the “checkout” button 108c has been touched on the basis of a signal from the input device 108.

In ACT10, the discount setting unit 1016 of the processor 101 sets whether or not to apply a discount to the registered commodities in accordance with the classification mode. Specifically, in ACT10, for example, the discount setting unit 1016 reflects the privilege information on the total amount of the ordinary commodities registered in the ordinary commodity registration mode. The discount setting unit 1016 reflects the discount amount or discount rate indicated by the privilege information on the total amount of the ordinary commodities for which the classification flag “0” is set. The discount may be applied according to a preset discount amount or discount rate in addition to the discount amount or discount rate indicated by the privilege information. On the other hand, the discount setting unit 1016 does not reflect the privilege information on the total amount of the non-commodity articles for which the classification flag “1” is set. Since the privilege information reflecting processing is well-known processing, the detailed description thereof will be omitted.

In ACT11, the point setting unit 1017 of the processor 101 sets whether or not to apply points to the registered commodities in accordance with the classification mode. Specifically, in ACT11, for example, the point setting unit 1017 applies points to the total amount of the ordinary commodities registered in the ordinary commodity registration mode. For example, the point setting unit 1017 reflects points, which is given according to a point giving rate indicated by the privilege information, on the total amount of the ordinary commodities. The point setting unit 1017 applies points to the total amount of the ordinary commodities for which the classification flag “0” is set. The point setting unit 1017 applies points to the total amount of the ordinary commodities on the basis of the member code obtained by the obtaining unit 1011. The points may be applied according to a preset point giving rate in addition to the point giving rate indicated by the privilege information. On the other hand, the point setting unit 1017 does not apply points to the total amount of the non-commodity articles for which the classification flag “1” is set. Since the point application processing is well-known processing, the detailed description thereof will be omitted.

According to this example, the POS terminal 10 classifies the registered commodities into the ordinary commodity registration mode and the non-commodity article registration mode, thus allowing various types of processing according to the classification mode. As a result, the operator can easily change whether or not to apply a discount or give points to the registered commodities in accordance with the classification mode on the POS terminal 10. Further, the POS terminal 10 can apply a discount or give points properly even if the operation policy for non-commodity articles is changed.

In ACT12, the settlement processing unit 1018 of the processor 101 executes settlement processing. Specifically, in ACT12, for example, the settlement processing unit 1018 performs settlement processing according to payment methods of cash, a credit card, a debit card, a gift certificate, and the like. For example, in the case of cash payment, the settlement processing unit 1018 calculates the deposit amount, and executes settlement processing when the calculated deposit amount exceeds the total amount. For example, in in the case of credit card settlement, the data of the credit card is read by the card reader 111, and the credit card is authenticated. When the credit card is authenticated, settlement processing is executed. In those types of settlement processing, the completed settlement information including the total amount, the payment method, the paid amount, and the like is stored in the auxiliary storage device 103. Since such settlement processing is well-known processing, the detailed description thereof will be omitted.

When the settlement processing unit 1018 of the processor 101 completes the settlement processing, the issuing unit 1019 of the processor 101 operates the printing device 110 to issue a receipt representing the contents of the present commercial transaction. The receipt includes, for example, information about the discount and information about the points.

Note that the above embodiment may include the following modifications. In the embodiment described above, the example in which the input device 108 includes the “back” button 108b for inputting the classification mode switching cancellation instruction for commodity registration has been described, but the embodiment is not limited thereto. The input device 108 may include no “back” button 108b. In this example, ACT7 and ACT8 of the flowchart shown in FIG. 4 can be omitted.

According to this example, since the installation of the “back” button 108b can be omitted in the POS terminal 10, the number of process steps by the POS terminal 10 can be reduced. Further, the operation by the operator can be simplified.

Although the POS terminal 10 is exemplified in the embodiment described above, at least part of the functions of the POS terminal 10 of this embodiment may be implemented in a so-called semi-self-service settlement apparatus with which a sales clerk registers commodities and a customer performs settlement. In addition, at least part of the functions of the POS terminal 10 of this embodiment may be implemented in a so-called full-self-service POS terminal with which a customer performs the operations from registration to settlement of the commodities. Furthermore, at least part of the functions of the POS terminal 10 of this embodiment may be implemented in a so-called cart POS terminal in which a commodity scanner and a dedicated terminal to be operated by a customer are attached to a cart, or in a so-called smartphone POS terminal in which commodity registration is performed using a terminal such as a tablet or smartphone.

Note that the commodity registration apparatus may be achieved by a single apparatus as described above with reference to the POS terminal 10 or may be achieved by a system in which the functions are distributed to a plurality of apparatuses.

Note that the transfer of the commodity registration apparatus is generally performed in a state where programs are stored in a main memory or an auxiliary storage device. However, the transfer of the commodity registration apparatus is not limited to this and may be performed in a state where programs are not stored in a main memory or an auxiliary storage device. In such a case, a program that has been transferred separately from a commodity registration apparatus is written to a recordable storage device of the commodity registration apparatus in accordance with an operation by a user or the like. The transfer of the program can be performed by recording it on a removable recording medium or by communication over a network. The recording medium may be any form as long as the program can be stored and can be read by the apparatus, like a CD-ROM, a memory card, or the like. In addition, the functions obtained by installing and downloading programs may be implemented in collaboration with an operating system (OS) or the like inside the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A commodity registration apparatus that registers a commodity to be sold in a commodity registration mode, comprising:
an input device configured to input a classification mode switching instruction for switching the commodity registration mode from a first classification mode to a second classification mode; and
a processor configured to
detect an input of the classification mode switching instruction by the input device,
switch the commodity registration mode from the first classification mode to the second classification mode in response to the detected classification mode switching instruction,
register a commodity to be registered as a commodity belonging to a first classification when the commodity registration mode is the first classification mode, and
register a commodity to be registered as a commodity belonging to a second classification different from the first classification when the commodity registration mode is switched from the first classification mode to the second classification mode.

2. The commodity registration apparatus according to claim 1, wherein
the processor is configured to set whether or not points can be given to a total amount of the registered commodity according to the classification mode.

3. The commodity registration apparatus according to claim 1, wherein
the processor is configured to set whether or not a discount can be applied to a total amount of the registered commodity according to the classification mode.

4. The commodity registration apparatus according to claim 3, wherein
the input device is further configured to input a classification mode switching cancellation instruction for switching the commodity registration mode from the second classification mode to the first classification mode, and
the processor is configured to
detect an input of the classification mode switching cancellation instruction by the input device, and
switch the commodity registration mode from the second classification mode to the first classification mode in response to the detected classification mode switching cancellation instruction.

5. The commodity registration apparatus according to claim 1, further comprising
a display device configured to display
a first commodity registration screen for registering a commodity belonging to the first classification, and
a second commodity registration screen for registering a commodity belonging to the second classification, wherein
the processor is configured to
cause the display device to display the first commodity registration screen when the commodity registration mode is the first classification mode, and
cause the display device to display the second commodity registration screen when the commodity registration mode is switched from first classification mode to the second classification mode.

6. The commodity registration apparatus according to claim 5, wherein
the first commodity registration screen includes a first mode notification indicating that the commodity registration mode is the first classification mode, and
the second commodity registration screen includes a second mode notification indicating that the commodity registration mode is the second classification mode.

7. The commodity registration apparatus according to claim 5, wherein
the input device includes
a first button for inputting the classification mode switching instruction for switching the commodity registration mode from the first classification mode to the second classification mode, and
a second button for inputting a classification mode switching cancellation instruction for switching the commodity registration mode from the second classification mode to the first classification mode, wherein
the first commodity registration screen includes the first button, and
the second commodity registration screen includes the second button.

8. The commodity registration apparatus according to claim 1, further comprising
a storage device configured to set a value of a classification flag indicating whether the commodity to be registered is a commodity belonging to the first classification or a commodity belonging to the second classification.

9. The commodity registration apparatus according to claim 8, wherein
the processor is configured to
give points to a total amount of the registered commodity on a basis of the value of the classification flag, the value being set by the storage device, and
apply a discount to the total amount of the registered commodity on the basis of the value of the classification flag, the value being set by the storage device.

10. A commodity registration method for a commodity registration apparatus that registers a commodity to be sold in a commodity registration mode, the method comprising:
inputting, by an input device, a classification mode switching instruction for switching the commodity registration mode from a first classification mode to a second classification mode;
detecting an input of the classification mode switching instruction by the input device;
switching the commodity registration mode from the first classification mode to the second classification mode in response to the detected classification mode switching instruction;
registering a commodity to be registered as a commodity belonging to a first classification when the commodity registration mode is the first classification mode; and
registering a commodity to be registered as a commodity belonging to a second classification different from the first classification when the commodity registration mode is switched from the first classification mode to the second classification mode.
